(19) United States
(12) Patent Application Publication
(10) Pub. No.: US 2016/0308923 A1
(43) Pub. Date: Oct. 20, 2016

(54) METHOD AND SYSTEM FOR PLAYING LIVE BROADCAST STREAMING MEDIA

(71) Applicants: LE SHI INTERNET INFORMATION TECHNOLOGY CORP. BEIJING, Beijing (CN); LE HOLDINGS (BEIJING) CO., LTD., Beijing (CN)

(72) Inventors: Kunbo CAO, Beijing (CN); Lei ZHENG, Beijing (CN)

(21) Appl. No.: 15/102,058

(22) PCT Filed: Nov. 25, 2014
(86) PCT No.: PCT/CN2014/092211

§ 371 Date: Jun. 6, 2016

(30) Foreign Application Priority Data
Dec. 9, 2013 (CN) 201310664858.3

(51) Int. Cl. H04L 29/06; H04N 21/218; H04N 21/432; G06F 17/30; H04N 21/472

(52) U.S. Cl. CPC H04L 65/4076; G06F 17/3005; G06F 17/30023; H04N 21/47202; H04N 21/4325; H04L 65/4084; H04N 21/2181

(57) ABSTRACT

The present invention relates to the field of Internet multimedia. A method and device are provided for playing live broadcast streaming media, being capable of improving the flexibility of playing live broadcast streaming media. The method comprises: acquiring a live broadcast streaming media search request, the search request comprising search information and search time, the search time indicating the time of generating the live broadcast streaming media search request; according to the search information, searching for live broadcast streaming media matching the search information; if the search time is earlier than the start time of playing the live broadcast streaming media, then playing an on-demand multimedia file corresponding to the search information in a media resource library; if the search time has reached or is later than the start time of playing the live broadcast streaming media, then playing the live broadcast streaming media at the start time.

This application claims the priority to Chinese Patent Application No. 201310664858.3, filed with the State Intellectual Property Office of People's Republic of China on Dec. 9, 2013 and entitled “Method and device for playing live broadcast streaming media)”, the content of which is hereby incorporated by reference in its entirety.

### FIELD

The present disclosure relates to the field of multimedia over the Internet and particularly to a method and device for playing live broadcast streaming media.

### BACKGROUND

Along with the development of Internet technologies, more and more people are interested in live broadcast over the Internet, particularly live videos over the Internet. People provided with a wide range of free options can watch online ball games, sports events, great events, news, etc., over the Internet.

Existing live videos over the internet are generally videos being played in real time, so the videos watched by a user are only the live videos being transmitted currently thereto, but the live videos cannot be shifted in time. Furthermore in the prior art, if the play start time of the live videos is not reached, then an electronic device can only present a blank screen on a live broadcast interface, and thus may be restricted in play performance.

### SUMMARY

Embodiments of the disclosure provide a method and device for playing live broadcast streaming media so as to address the problem in the prior art that if the play start time is not reached, then the electronic device can only present the blank screen on the live broadcast interface, to thereby improving the flexibility in playing the live broadcast streaming media.

In order to attain the object above, there are the following technical solutions according to the embodiments of the disclosure:

An embodiment of the disclosure provides a method for playing live broadcast streaming media, the method including:

obtaining a live broadcast streaming media search request including search information, and search time indicating the time when the live broadcast streaming media search request is generated;

searching for live broadcast streaming media matching with the search information according to the search information; and

if the search time is earlier than a play start time of the live broadcast streaming media, then playing an on-demand multimedia file matching with the search information, in a media resource library, and

if the search time reaches or is later than the play start time of the live broadcast streaming media, then playing the live broadcast streaming media from the play start time.

after the on-demand multimedia file matching with the search information, in the media resource library is played, the method further includes:

loading a live broadcast streaming media play interface; and

playing the live broadcast streaming media on the live broadcast streaming media play interface when the play start time of the live broadcast streaming media is reached.

The step of playing the on-demand multimedia file matching with the search information, in the media resource library includes:

retrieving the on-demand multimedia file matching with the search information from the media resource library according to the search information; and

loading an on-demand media play interface, and playing the on-demand multimedia file on the on-demand media play interface.

The method further comprises:

storing the live broadcast streaming media in real time.

The step of playing the live broadcast streaming media from the play start time includes:

retrieving the stored live broadcast streaming media, and loading a live broadcast streaming media play interface; and

playing the live broadcast streaming media from the play start time on the live broadcast streaming media play interface.

An embodiment of the disclosure provides an electronic device including:

an obtaining unit configured to obtain a live broadcast streaming media search request including search information, and search time indicating the time when the live broadcast streaming media search request is generated;

a searching unit configured to search for live broadcast streaming media matching with the search information obtained by the obtaining unit according to the search information; and

a playing unit configured, if the search time is earlier than a play start time of the live broadcast streaming media retrieved by the searching unit, to play an on-demand multimedia file corresponding to the search information, in a media resource library, and if the search time reaches or is later than the play start time of the live broadcast streaming media retrieved by the searching unit, to play the live broadcast streaming media retrieved by the searching unit from the play start time.

The electronic device further includes a processing unit, wherein:

the processing unit is configured to load a live broadcast streaming media play interface after the playing unit plays the on-demand multimedia file corresponding to the search information, in the media resource library; and

the playing unit is configured to play the live broadcast streaming media retrieved by the searching unit on the live broadcast streaming media play interface loaded by the processing unit, when the play start time of the live broadcast streaming media is reached.

The obtaining unit is further configured to retrieve the on-demand multimedia file matching with the search information from the media resource library according to the search information;

the processing unit is further configured to load an on-demand media play interface; and

the playing unit is further configured to play the on-demand multimedia file retrieved by the obtaining unit on the on-demand media play interface loaded by the processing unit.

The electronic device further includes a storage unit, wherein:

the storage unit is configured to store the live broadcast streaming media retrieved by the searching unit in real time.

The obtaining unit is further configured to retrieve the live broadcast streaming media stored by the storing unit; and

the processing unit is further configured to load the live broadcast streaming media play interface after the obtaining unit retrieves the stored live broadcast streaming media.

The embodiments of the disclosure provide a method and device for playing live broadcast streaming media so that the electronic device obtains the live broadcast streaming media search request including the search information, and the search time indicating the time when the live broadcast streaming media search request is generated, and then searches for the live broadcast streaming media matching with the search information according to the search information, and if the search time is earlier than play start time of the live broadcast streaming media, then the electronic device plays the on-demand multimedia file corresponding to the search information, in the media resource library; and if the search time reaches or is later than the play start time of the live broadcast streaming media, then the electronic device plays the live broadcast streaming media from the play start time. With this solution, in the scenario where the search time is earlier than the play start time of the live broadcast streaming media, the electronic device plays the on-demand multimedia file matching with the search information, and if the search time reaches the play start time of the live broadcast streaming media, then the electronic device stores the live broadcast streaming media in real time; and in the scenario where the search time is later than the play start time of the live broadcast streaming media, the electronic device plays the live broadcast streaming media from the play start time of the live broadcast streaming media, thus enabling the user to rewind the live broadcast streaming media for watching so as to improve the flexibility in playing the live broadcast streaming media.

### BRIEF DESCRIPTION OF THE DRAWINGS

In order to make the technical solutions in the embodiments of the disclosure or the prior art more apparent, the drawings to which the embodiments or the prior art are described with reference will be briefly introduced below, and apparently the drawings to be described below are merely illustrative of some of the embodiments of the disclosure, and those ordinarily skilled in the art can derive from these drawings other drawings without any inventive effort. In the drawings:

FIG. 1 is a first schematic flow chart of a method for playing live broadcast streaming media according to an embodiment of the disclosure;

FIG. 2 is a second schematic flow chart of a method for playing live broadcast streaming media according to an embodiment of the disclosure;

FIG. 3 is a first schematic structural diagram of an electronic device according to an embodiment of the disclosure; and

FIG. 4 is a second schematic structural diagram of an electronic device according to an embodiment of the disclosure.

### DETAILED DESCRIPTION OF THE EMBODIMENTS

The technical solutions according to the embodiments of the disclosure will be described clearly and fully with reference to the drawings in the embodiments of the disclosure. Apparently the described embodiments are only a part but all of the embodiments of the disclosure. Based upon the embodiments here of the disclosure, all of other embodiments derived by those ordinarily skilled in the art without any inventive effort shall come into the scope of the disclosure.

An electronic device can be a wireless terminal or a wired terminal, and the wireless terminal can refer to a device providing a user with voice and/or data connectivity, a handheld device capable of wireless connection, or another processing device connected with a wireless modem. The wireless terminal can communicate with one or more core network over a wireless access network (e.g., a Radio Access Network (RAN)), and the wireless terminal can be a mobile terminal, e.g., a mobile phone (or referred to as a “cellular” phone), or a computer provided with a mobile terminal.

### First Embodiment

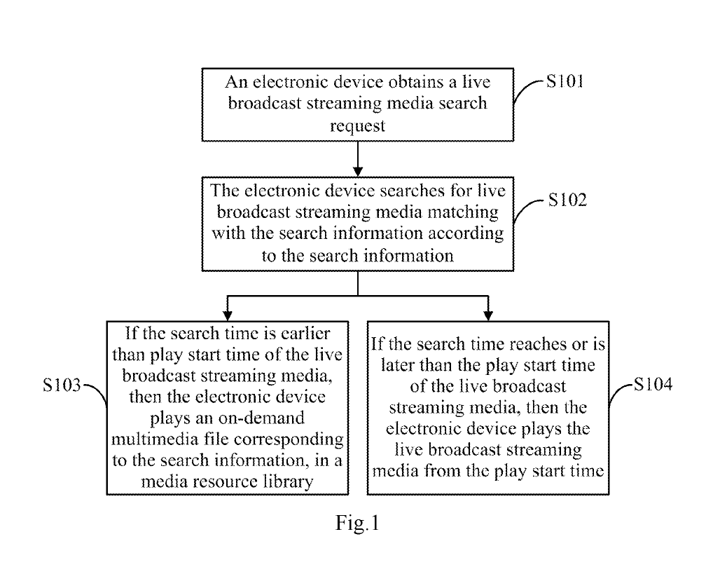

An embodiment of the disclosure provides a method for playing live broadcast streaming media as illustrated in FIG. 1, the method includes:

S101. An electronic device obtains a live broadcast streaming media search request.

Live broadcast refers to live production and distribution of information, in synchronization with occurrence and progression of an event, where the information is distributed through bidirectional transmission over a network. It can be embodied as spot live broadcast, studio interview live broadcast, text and picture live broadcast, audio and video live broadcast, and live broadcast of signal source provided by third-party. For example, online video live broadcast is a spot live broadcast service provided over network resources, where spot videos are captured and uploaded synchronously onto the network so that users can watch the spot videos at the earliest time over the network at the same time.

Streaming media refers to a process in which a series of media data are compressed, and then segments of the data are transported over the network, so that audios and videos are transmitted in real time over the network for watching, where this process enables the segmented data to be streamed. Without this process, the entire media file would have to be downloaded before an access thereto.

Particularly streaming media refers to a technology in which audios, videos, and other multimedia elements are played in real time over the Internet and wireless networks without waiting. Streaming refers to that videos, audios, and other multimedia files are specially compressed into separate packages, and the packages are transported consecutively in real time by a server to a user computer. In a system where media are streamed, instead of watching the contents of the file, which are played but not streamed, only after the entire file is downloaded, the user can play the compressed audios, videos, or other streamed media files on the user computer using a corresponding player after a start delay of only several seconds or tens of seconds while the remaining media are further downloaded until the entire file is played.

The electronic device plays the live broadcast streaming media by firstly knowing information about the live broadcast streaming media to be played, and then playing the live broadcast streaming media to be played according to the information about the live broadcast streaming media to be played.

Particularly the electronic device obtains the live broadcast streaming media search request including search information and search time, where the search information indicates the live broadcast streaming media to be played, and the search time is the time when the live broadcast streaming media search request is generated, so that the electronic device determines whether the search time reaches a play start time of the live broadcast streaming media to be played, for subsequent processing.

Furthermore the electronic device can determine from the search time whether there is a resource corresponding to the search information in the live broadcast streaming media search request for playing.

It shall be noted that the live broadcast streaming media can be multimedia in any one format, and the live broadcast streaming media in the embodiment of the disclosure can be live videos or live audios, but the embodiment of the disclosure will not be limited thereto.

S102. The electronic device searches for the live broadcast streaming media matching with the search information according to the search information.

After obtaining the live broadcast streaming media search request, the electronic device searches for the live broadcast streaming media matching with the search information in the request through a live broadcast streaming media server according to the search information.

For example, if the information about the live broadcast streaming media searched for in accordance with the live broadcast streaming media search request shows Chinese Super League, and the request is generated at the time of 9:00, then the electronic device obtaining the live broadcast streaming media search request searches for the live broadcast streaming media matching with Chinese Super League according to the search information of Chinese Super League.

S103. If the search time is earlier than play start time of the live broadcast streaming media, then the electronic device plays an on-demand multimedia file corresponding to the search information, in a media resource library.

The media resource library refers to a database of media resources possessed or controlled by media, where the media resources include materials, programs, documents, etc.

After obtaining the live broadcast streaming media search request, and searching for the live broadcast streaming media matching with the search information in the search request according to the search information, the electronic device then judges whether the play start time of the live broadcast streaming media is reached.

Particularly if the search time is earlier than play start time of the live broadcast streaming media, then no resource of the live broadcast streaming media can be played by the electronic device. In this application scenario, the electronic device plays the on-demand multimedia file corresponding to the search information, in the media resource library, on an on-demand media play interface according to the search information, and also loads a live broadcast streaming media play interface for subsequent playing of the live broadcast streaming media.

Here the on-demand multimedia file corresponding to the search information, in the media resource library is any one on-demand multimedia file corresponding to the live broadcast streaming media, which can be trailer multimedia of the live broadcast streaming media or bloopers of the live broadcast streaming media, but the embodiment of the disclosure will not be limited thereto.

Since in the application scenario where the search time is earlier than the play start time of the live broadcast streaming media, the electronic device plays the on-demand multimedia file corresponding to the search information in the media resource library, the experience of the user can be improved.

It shall be noted that the play interface of the live broadcast streaming media is a different interface from the play interface of the on-demand multimedia file in the media resource library.

For example, if the information about the live broadcast streaming media searched for in the live broadcast streaming media search request is Chinese Super League, and the request is generated at the time of 9:00, then the electronic device obtaining the live broadcast streaming media search request searches for the live broadcast streaming media matching with Chinese Super League, and the play start time of the searched out live broadcast streaming media is 09:30, so the electronic device retrieves the on-demand multimedia file matching with Chinese Super League from the media resource library, loads the on-demand media play interface, and plays the on-demand multimedia file on the on-demand media play interface, where the on-demand multimedia file can be trailer videos of Chinese Super League.

S104. If the search time reaches or is later than the play start time of the live broadcast streaming media, then the electronic device plays the live broadcast streaming media from the play start time.

After obtaining the live broadcast streaming media search request, and searching for the live broadcast streaming media matching with the search information in the search request according to the search information, the electronic device then judges whether the play start time of the live broadcast streaming media is reached.

Particularly if the search time reaches the play start time of the live broadcast streaming media, then the electronic device plays the live broadcast streaming media from the play start time of the live broadcast streaming media on the live broadcast streaming media play interface, and stores the live broadcast streaming media in real time while the live broadcast streaming media is being played;

Or

If the search time is later than the play start time of the live broadcast streaming media, then the electronic device plays the live broadcast streaming media on the live broadcast streaming media play interface, and plays the live broadcast streaming media from the play start time of the live broadcast streaming media.

The electronic device stores the live broadcast streaming media in real time, so even if the search time is later than the play start time of the live broadcast streaming media, the electronic device can play the live broadcast streaming media from the play start time of the live broadcast streaming media, thus improving the flexibility in playing the live broadcast streaming media so as to satisfy the demand of the user and to improve the experience of the user.

The embodiment of the disclosure provides a method for playing live broadcast streaming media so that the electronic device obtains the live broadcast streaming media search request including the search information, and the search time indicating the time when the live broadcast streaming media search request is generated, and then searches for the live broadcast streaming media matching with the search information according to the search information, and if the search time is earlier than play start time of the live broadcast streaming media, then the electronic device plays the on-demand multimedia file corresponding to the search information, in the media resource library; and if the search time reaches or is later than the play start time of the live broadcast streaming media, then the electronic device plays the live broadcast streaming media from the play start time. With this solution, in the scenario where the search time is earlier than the play start time of the live broadcast streaming media, the electronic device plays the on-demand multimedia file matching with the search information, and if the search time reaches the play start time of the live broadcast streaming media, then the electronic device stores the live broadcast streaming media in real time; and in the scenario where the search time is later than the play start time of the live broadcast streaming media, the electronic device plays the live broadcast streaming media from the play start time of the live broadcast streaming media, thus enabling the user to rewind the live broadcast streaming media for watching so as to improve the flexibility in playing the live broadcast streaming media.

### Second Embodiment

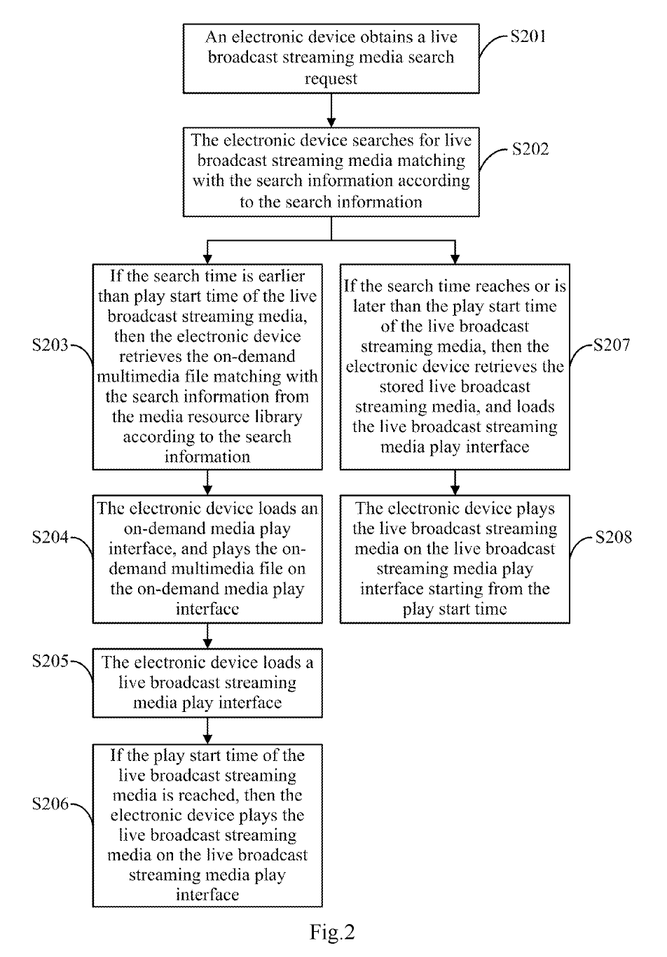

An embodiment of the disclosure provides a method for playing live broadcast streaming media as illustrated in FIG. 2, the method includes:

S201. An electronic device obtains a live broadcast streaming media search request.

Here the live broadcast streaming media search request includes search information, and search time indicating the time when the live broadcast streaming media search request is generated.

Live broadcast refers to live production and distribution of information, in synchronization with occurrence and progression of an event, where the information is distributed through bidirectional transmission over a network. It can be embodied as spot live broadcast, studio interview live broadcast, text and picture live broadcast, audio and video live broadcast, and live broadcast of signal source provided by third-party. For example, online video live broadcast is a spot live broadcast service provided over network resources, where spot videos are captured and uploaded synchronously onto the network so that users can watch the spot videos at the earliest time over the network at the same time.

Streaming media refers to a process in which a series of media data are compressed, and then segments of the data are transported over the network, so that audios and videos are transmitted in real time over the network for watching, where this process enables the segmented data to be streamed. Without this process, the entire media file would have to be downloaded before an access thereto.

Particularly streaming media refers to a technology in which audios, videos, and other multimedia elements are played in real time over the Internet and wireless networks without waiting. Streaming refers to that videos, audios, and other multimedia files are specially compressed into separate packages, and the packages are transported consecutively in real time by a server to a user computer. In a system where media are streamed, instead of watching the contents of the file, which are played but not streamed, only after the entire file is downloaded, the user can play the compressed audios, videos, or other streamed media files on the user computer using a corresponding player after a start delay of only several seconds or tens of seconds while the remaining media are further downloaded until the entire file is played.

The electronic device plays the live broadcast streaming media by firstly knowing information about the live broadcast streaming media to be played, and then playing the live broadcast streaming media to be played according to the information about the live broadcast streaming media to be played.

Particularly the electronic devices obtains the live broadcast streaming media search request including search information and search time, where the search information indicates the live broadcast streaming media to be played, and the search time is the time when the live broadcast streaming media search request is generated, so that the electronic device determines whether the search time reaches a play start time of the live broadcast streaming media to be played, for subsequent processing.

Furthermore the electronic device can determine from the search time whether there is a resource corresponding to the search information in the live broadcast streaming media search request for playing.

It shall be noted that the live broadcast streaming media are multimedia in any one format, and the live broadcast streaming media in the embodiment of the disclosure can be live videos or live audios, but the embodiment of the disclosure will not be limited thereto.

S202. The electronic device searches for the live broadcast streaming media matching with the search information according to the search information.

After obtaining the live broadcast streaming media search request, the electronic device searches for the live broadcast streaming media matching with the search information in the request through a live broadcast streaming media server according to the search information.

For example, if the information about the live broadcast streaming media searched for in accordance with the live broadcast streaming media search request shows Chinese Super League, and the request is generated at the time of 9:00, then the electronic device obtaining the live broadcast streaming media search request searches for the live broadcast streaming media matching with Chinese Super League according to the search information of Chinese Super League.

S203. If the search time is earlier than play start time of the live broadcast streaming media, then the electronic device retrieves an on-demand multimedia file matching with the search information from the media resource library according to the search information.

The media resource library refers to a database of media resources possessed or controlled by media, where the media resources include materials, programs, documents, etc.

After obtaining the live broadcast streaming media search request, and searching for the live broadcast streaming media matching with the search information in the search request according to the search information, the electronic device then judges whether the play start time of the live broadcast streaming media is reached.

Particularly if the search time is earlier than play start time of the live broadcast streaming media, then no resource of the live broadcast streaming media can be played by the electronic device. In this application scenario, the electronic device searches the media resource library for the on-demand multimedia file corresponding to the search information according to the search information for later playing.

Here the on-demand multimedia file corresponding to the search information, in the media resource library is any one on-demand multimedia file corresponding to the live broadcast streaming media, which can be trailer multimedia of the live broadcast streaming media or bloopers of the live broadcast streaming media, but the embodiment of the disclosure will not be limited thereto.

For example, if the information about the live broadcast streaming media searched for in the live broadcast streaming media search request is Chinese Super League, and the request is generated at the time of 9:00, then the electronic device obtaining the live broadcast streaming media search request searches for the live broadcast streaming media matching with Chinese Super League, and the play start time of the searched out live broadcast streaming media is 09:30, so the electronic device retrieves the on-demand multimedia file matching with Chinese Super League from the media resource library for later playing.

S204. The electronic device loads an on-demand media play interface, and plays the on-demand multimedia file on the on-demand media play interface.

The electronic device retrieves the on-demand multimedia file matching with the search information from the media resource library, and then plays the retrieved on-demand multimedia file, upon determining that the current time is earlier than the play start time of the live broadcast streaming media corresponding to the search information.

Particularly the electronic device loads the on-demand media play interface, and plays the on-demand multimedia file, matching with the search information, retrieved from the media resource library, on the on-demand media play interface.

In the application scenario where the search time is earlier than the play start time of the live broadcast streaming media, the electronic device plays the on-demand multimedia file corresponding to the search information, in the media database to thereby satisfy the demand of the user to some extent so as to improve the experience of the user.

It shall be noted that the play interface of the live broadcast streaming media is a different interface from the play interface of the on-demand multimedia file in the media database.

For example, if CCTV's Spring Festival Gala is searched for at 19:50, and the play start time of the live CCTV's Spring Festival Gala is 20:00, then the electronic device retrieves an on-demand multimedia file (trailer videos) matching with CCTV's Spring Festival Gala from the media resource library, loads an on-demand media play interface, and plays the trailer videos on the on-demand media play interface.

S205. The electronic device loads a live broadcast streaming media play interface.

The electronic device loads the live broadcast streaming media play interface upon determining that the current time is earlier than the play start time of the live broadcast streaming media corresponding to the search information, waits until arrival of the play time of the live broadcast streaming media corresponding to the search information, and then plays the live broadcast streaming media.

Particularly the electronic device can present a black screen or display a preset picture, on the live broadcast streaming media play interface while waiting for arrival of the play time of the live broadcast streaming media corresponding to the search information, although the embodiment of the disclosure will not be limited thereto.

S206. If the play start time of the live broadcast streaming media is reached, then the electronic device plays the live broadcast streaming media on the live broadcast streaming media play interface.

Particularly, if the search time is earlier than play start time of the live broadcast streaming media, then the electronic device loads the live broadcast streaming media play interface. If the play start time of the live broadcast streaming media is reached, then the electronic device plays the live broadcast streaming media on the live broadcast streaming media play interface, and stores the live broadcast streaming media in real time.

For example, if CCTV's Spring Festival Gala is searched for at 19:50, and the play start time of the live CCTV's Spring Festival Gala is 20:00, then the electronic device retrieves a multimedia file (trailer videos) matching with the CCTV's Spring Festival Gala from the media resource library, plays the trailer videos on the on-demand multimedia play interface, and loads the live broadcast streaming media play interface for later playing of the live CCTV's Spring Festival Gala; and if it is 20:00, then the electronic device plays the CCTV's Spring Festival Gala on the live broadcast streaming media play interface, and stores it in real time.

S207. If the search time reaches or is later than the play start time of the live broadcast streaming media, then the electronic device retrieves the stored live broadcast streaming media, and loads the live broadcast streaming media play interface.

After obtaining the live broadcast streaming media search request, and searching for the live broadcast streaming media matching with the search information in the search request according to the search information, the electronic device then determines whether the play start time of the live broadcast streaming media is reached.

Particularly if the search time reaches the play start time of the live broadcast streaming media, then the electronic device retrieves the live broadcast streaming media through the live broadcast streaming media server, and also loads the live broadcast streaming media play interface for later playing of the live broadcast streaming media;

Or

If the search time is later than the play start time of the live broadcast streaming media, then the electronic device retrieves the live broadcast streaming media from a buffer, and also loads the live broadcast streaming media play interface for later playing of the live broadcast streaming media.

Furthermore the electronic device stores the live broadcast streaming media in real time, so even if the search time is later than the play start time of the live broadcast streaming media, then the electronic device can retrieve the live broadcast streaming media.

S208. The electronic device plays the live broadcast streaming media on the live broadcast streaming media play interface starting from the play start time.

Particularly if the search time reaches or is later than the play start time of the live broadcast streaming media, then the electronic device plays the retrieved live broadcast streaming media on the live broadcast streaming media play interface starting from the play start time.

Furthermore the electronic device stores the live broadcast streaming media in real time, so even if the search time is later than the play start time of the live broadcast streaming media, then the electronic device can play the live broadcast streaming media from the play start time of the live broadcast streaming media, thus satisfying the demand of the user and improving the experience of the user.

For example, if Chinese Super League is searched for at 21:00, and the play start time of the live Chinese Super League is 20:00, then the electronic device loads the live play interface, and plays the live Chinese Super League form the play start time.

The embodiment of the disclosure provides a method for playing live broadcast streaming media so that the electronic device obtains the live broadcast streaming media search request including the search information, and the search time indicating the time when the live broadcast streaming media search request is generated, and then searches for the live broadcast streaming media matching with the search information according to the search information, and if the search time is earlier than play start time of the live broadcast streaming media, then the electronic device plays the on-demand multimedia file corresponding to the search information, in the media resource library; and if the search time reaches or is later than the play start time of the live broadcast streaming media, then the electronic device plays the live broadcast streaming media from the play start time. With this solution, in the scenario where the search time is earlier than the play start time of the live broadcast streaming media, the electronic device plays the on-demand multimedia file matching with the search information, and if the search time reaches the play start time of the live broadcast streaming media, then the electronic device stores the live broadcast streaming media in real time; and in the scenario where the search time is later than the play start time of the live broadcast streaming media, the electronic device plays the live broadcast streaming media from the play start time of the live broadcast streaming media, thus enabling the user to rewind the live broadcast streaming media for watching so as to improve the flexibility in playing the live broadcast streaming media.

### Third Embodiment

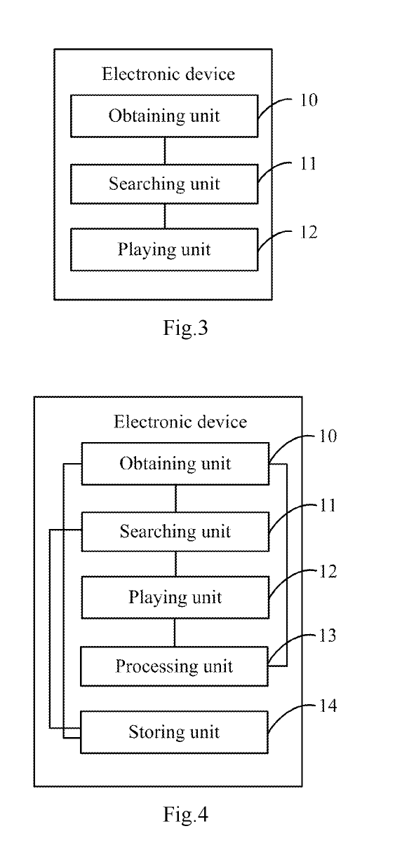

An embodiment of the disclosure provides an electronic device, and as illustrated in FIG. 3, the electronic device includes:

An obtaining unit 10 is configured to obtain a live broadcast streaming media search request including search information and search time indicating the time when the live broadcast streaming media search request is generated;

A searching unit 11 is configured to search for live broadcast streaming media matching with the search information obtained by the obtaining unit 10 according to the search information; and

A playing unit 12 is configured, if the search time is earlier than a play start time of the live broadcast streaming media retrieved by the searching unit 11, to play an on-demand multimedia file corresponding to the search information, in a media resource library, and if the search time reaches or is later than the play start time of the live broadcast streaming media retrieved by the searching unit 11, to play the live broadcast streaming media retrieved by the searching unit 11 from the play start time.

Further, as illustrated in FIG. 4, the electronic device includes a processing unit 13.

The processing unit 13 is configured to load a live broadcast streaming media play interface after the playing unit 12 plays the on-demand multimedia file corresponding to the search information, in the media resource library.

The playing unit 12 is configured to play the live broadcast streaming media retrieved by the searching unit 11 on the live broadcast streaming media play interface loaded by the processing unit 13, when the play start time of the live broadcast streaming media is reached.

Further, the obtaining unit 10 is configured to retrieve the on-demand multimedia file matching with the search information from the media resource library according to the search information.

The processing unit 13 is further configured to load an on-demand media play interface.

The playing unit 12 is further configured to play the on-demand multimedia file retrieved by the obtaining unit 10 on the on-demand media play interface loaded by the processing unit 13.

Further, as illustrated in FIG. 4, the electronic device further includes a storing unit 14.

The storing unit 14 is configured to store the live broadcast streaming media retrieved by the searching unit 11 in real time.

Further, the obtaining unit 10 is further configured to retrieve the live broadcast streaming media stored by the storing unit 14.

The processing unit 13 is further configured to load the live broadcast streaming media play interface after the obtaining unit 10 retrieves the stored live broadcast streaming media.

The embodiment of the disclosure provides an electronic device so that the electronic device obtains the live broadcast streaming media search request including the search information, and the search time indicating the time when the live broadcast streaming media search request is generated, and then searches for the live broadcast streaming media matching with the search information according to the search information, and if the search time is earlier than play start time of the live broadcast streaming media, then the electronic device plays the on-demand multimedia file in the media resource library, corresponding to the search information; and if the search time reaches or is later than the play start time of the live broadcast streaming media, then the electronic device plays the live broadcast streaming media from the play start time. With this solution, in the scenario where the search time is earlier than the play start time of the live broadcast streaming media, the electronic device plays the on-demand multimedia file matching with the search information, and if the search time reaches the play start time of the live broadcast streaming media, then the electronic device stores the live broadcast streaming media in real time; and in the scenario where the search time is later than the play start time of the live broadcast streaming media, the electronic device plays the live broadcast streaming media from the play start time of the live broadcast streaming media, thus enabling the user to rewind the live broadcast streaming media for watching so as to improve the flexibility in playing the live broadcast streaming media.

Those skilled in the art can readily appreciate that the respective functional modules have been described above for the sake of convenience and conciseness, but in a practical application, the functions above can be allocated to the different functional modules as needed, that is, the internal structure of the devices can be divided into the different functional modules for performing all or a part of the functions described above. Reference can be made to the corresponding processes in the embodiments of the methods described earlier for particular operation processes of the system, the devices and the units described above, so a repeated description thereof will be omitted here.

In the several embodiments of the disclosure, it shall be appreciated that the disclosed system, devices and the methods can be embodied otherwise. For example the embodiments of the devices described above are merely illustrative, for example, the devices have been just divided into the modules or the units in terms of their logical functions but can be divided otherwise in a real implementation, for example, more than one of the units or the components can be combined or can be integrated into another system, or some of the features can be ignored or may not be implemented. Furthermore the illustrated or described coupling or direct coupling or communication connection between the units or the components can be established via some interfaces, and indirect coupling or communication connection between the devices or units can be electrical, mechanical or in another form.

The foregoing disclosure is illustrative of the particular embodiments of the disclosure, but the disclosure shall not be limited thereto; and any variations or equivalents which can readily occur to those skilled in the art without departing from the scope of the disclosure of the disclosure shall fall into the scope of the disclosure. Accordingly the scope of the disclosure shall be as defined in the appended claims.

1. A method for playing a live broadcast streaming media, the method comprising:
obtaining a live broadcast streaming media search request comprising search information, and search time indicating the time when the live broadcast streaming media search request is generated; and
searching for live broadcast streaming media matching with the search information according to the search information; wherein,
if the search time is earlier than a play start time of the live broadcast streaming media, then playing an on-demand multimedia file matching with the search information in a media resource library, and
if the search time reaches or is later than the play start time of the live broadcast streaming media, then playing the live broadcast streaming media from the play start time.

2. The method according to claim 1, wherein after the on-demand multimedia file matching with the search information in the media resource library is played, the method further comprises:
loading a live broadcast streaming media play interface; and
playing the live broadcast streaming media on the live broadcast streaming media play interface when the play start time of the live broadcast streaming media is reached.

3. The method according to claim 1, wherein playing the on-demand multimedia file matching with the search information in the media resource library comprises:
retrieving the on-demand multimedia file matching with the search information from the media resource library according to the search information; and
loading an on-demand media play interface, and playing the on-demand multimedia file on the on-demand media play interface.

4. The method according to claim 1, further comprising:
storing the live broadcast streaming media in real time.

5. The method according to claim 4, wherein playing the live broadcast streaming media from the play start time comprises:
retrieving the stored live broadcast streaming media, and loading a live broadcast streaming media play interface; and
playing the live broadcast streaming media from the play start time on the live broadcast streaming media play interface.

6. An electronic device, comprising:
one or more processor; and
a memory, wherein:
one or more computer readable program codes are stored in the memory, and the one or more processors are configured to execute the one or more computer readable program codes to perform:
obtaining a live broadcast streaming media search request comprising search information, and search time indicating the time when the live broadcast streaming media search request is generated; and
searching for live broadcast streaming media matching with the search information according to the search information; wherein
if the search time is earlier than a play start time of the live broadcast streaming media, then playing an on-demand multimedia file corresponding to the search information in a media resource library, and if the search time reaches or is later than the play start time of the live broadcast streaming media, then playing the live broadcast streaming media from the play start time.

7. The electronic device according to claim 6, wherein the one or more processors are further configured to execute the one or more computer readable program codes to perform:
loading a live broadcast streaming media play interface after playing the on-demand multimedia file corresponding to the search information in the media resource library; and
playing the live broadcast streaming media on the live broadcast streaming media play interface when the play start time of the live broadcast streaming media is reached.

8. The electronic device according to claim 7, wherein the one or more processors are further configured to execute the one or more computer readable program codes to perform:
retrieving the on-demand multimedia file matching with the search information from the media resource library according to the search information;
loading an on-demand media play interface; and
playing the on-demand multimedia file on the on-demand media play interface.

9. The electronic device according to claim 6, wherein
the memory is configured to store the live broadcast streaming media in real time.

10. The electronic device according to claim 8, wherein the one or more processors are further configured to execute the one or more computer readable program codes to perform:
retrieving the live broadcast streaming media stored by the memory; and
loading the live broadcast streaming media play interface after retrieving the stored live broadcast streaming media.

11. The method according to claim 2, further comprising:
storing the live broadcast streaming media in real time.

12. The method according to claim 3, further comprising:
storing the live broadcast streaming media in real time.

13. The method according to claim 11, wherein playing the live broadcast streaming media from the play start time comprises:
retrieving the stored live broadcast streaming media, and loading a live broadcast streaming media play interface; and
playing the live broadcast streaming media from the play start time on the live broadcast streaming media play interface.

14. The method according to claim 12, wherein playing the live broadcast streaming media from the play start time comprises:
retrieving the stored live broadcast streaming media, and loading a live broadcast streaming media play interface; and
playing the live broadcast streaming media from the play start time on the live broadcast streaming media play interface.

15. The electronic device according to claim 7, wherein the memory is configured to store the live broadcast streaming media in real time.

16. The electronic device according to claim 8, wherein the memory is configured to store the live broadcast streaming media in real time.

17. The electronic device according to claim 15, wherein the one or more processors are further configured to execute the one or more computer readable program codes to perform:
retrieving the live broadcast streaming media stored by the memory; and
loading the live broadcast streaming media play interface after retrieving the stored live broadcast streaming media.

18. The electronic device according to claim 16, wherein the one or more processors are further configured to execute the one or more computer readable program codes to perform:
retrieving the live broadcast streaming media stored by the memory; and
loading the live broadcast streaming media play interface after retrieving the stored live broadcast streaming media.
